(19) United States
(12) Patent Application Publication
(10) Pub. No.: US 2004/0257618 A1
(43) Pub. Date: Dec. 23, 2004

(54) Image forming method and system, and image forming apparatus

(75) Inventor: Yong Ning Wang, Ibaraki-ken (JP)

Correspondence Address: FROMMER LAWRENCE & HAUG LLP, 745 FIFTH AVENUE, NEW YORK, NY, 10151, US

(73) Assignee: Riso Kagaku Corporation, Tokyo (JP)

(21) Appl. No.: 10/855,222

(22) Filed: May 27, 2004

(30) Foreign Application Priority Data
May 27, 2003 (JP) 148590/2003

(51) Int. Cl. G06F 13/00; H04N 1/21

(52) U.S. Cl. 358/1.17; 358/404

(57) ABSTRACT

In cases where it has been judged that image data for predetermined pages are capable of being stored in a free storage area of a storage section of a printer, the image data for the predetermined pages are stored and held in the storage section. In the printer, an image forming process is iterated the number of times equal to the number of copies. The image forming process comprises reading of the image data for the predetermined pages from the storage section, acceptance of the image data for the remaining pages outputted from a print control apparatus, and formation of an image represented by image information composed of the image data for the predetermined pages having been read from the storage section and the image data for the remaining pages having been accepted from the print control apparatus.

### BACKGROUND OF THE INVENTION

1. Field or the Invention

This invention relates to an image forming method and system for forming a plurality of copies of an image, which is represented by image information constituted of image data for a plurality of pages. This invention also relates to an image forming apparatus for use in the image forming system.

2. Description of the Related Art

Recently, printers, such as inkjet printers and laser printers, have become popular. Also, printer systems, which comprise a printer and a computer connected to the printer via an interface device, and with which an image represented by image information having been outputted from the computer is printed, have been used in practice.

FIG. 7 is an explanatory view showing how a conventional printer system operates. With the printer systems described above, as illustrated in FIG. 7, in cases where a plurality of copies of an image, which is represented by image information constituted of image data for a plurality of pages, are printed, the same number of sheets of each of the pages as that of the copies are printed successively. Therefore, after all of the pages have been printed, it is necessary to perform an operation for assorting the pages in order to combine the pages constituting each of the copies of the image.

Therefore, a technique for utilizing a controller for obtaining a pseudo sorter function has been proposed in, for example, Japanese Unexamined Patent Publication No. 6(1994)-40121. With the proposed technique for utilizing a controller for obtaining a pseudo sorter function, the controller receives image information, which is constituted of image data for a plurality of pages, and information, which represents the number of print copies, from a computer and outputs the image data for each of the pages into a printer in accordance with the received information. FIG. 8 and FIG. 9 are explanatory views showing how a conventional printer system operates. Specifically, as illustrated in FIG. 8, the controller forms a plurality of pieces of information, each of which pieces of information is utilized for printing the image data for each of the pages on one sheet, in a number equal to the number of the print copies and outputs the thus formed pieces of information in the order of the pages into the printer. As a result, the image data for the plurality of the pages are printed in the order illustrated in FIG. 9.

However, in cases where, as in the technique proposed in Japanese Unexamined Patent Publication No. 6(1994)-40121, the operation for outputting the plurality of the pieces of information, each of which pieces of information is utilized for printing the image data for each of the pages on one sheet, from the controller into the printer is iterated a number of times, which is equal to the number of the plurality of the print copies, a longtime is required to transfer the image data. Also, while the image data is being transferred, the processing efficiency of a CPU of the controller becomes low, and processing of the image information, which is inputted next into the controller, and the like, are not capable of being performed efficiently. Further, a long time is required for the printer to accept the image data. Therefore, the print processing time is not capable of being kept short. Specifically, the processing efficiency of the entire print processing is not capable of being kept high.

### SUMMARY OF THE INVENTION

The primary object of the present invention is to provide an image forming method for forming a plurality of copies of an image, which is represented by image information constituted of image data for a plurality of pages, wherein the image information constituted of the image data for the plurality of the pages is capable of being outputted in units of copy, and an efficiency with which print processing is performed is capable of being enhanced.

Another object of the present invention is to provide an image forming system for carrying out the image forming method.

The specific object of the present invention is to provide an image forming apparatus for use in the image forming system.

The present invention provides an image forming method, wherein print information, which contains image information constituted of image data for a plurality of pages, is inputted into a print control apparatus, the image data for each of the pages, which image data constitutes the image information, is outputted from the print control apparatus and in accordance with the print information, and formation of an image represented by the image information is iterated a number of times equal to the number of a plurality of copies, the formation of the image being iterated by an image forming apparatus and in accordance with the image data having been outputted from the print control apparatus, the method comprising the steps of:

i) locating a storage section, which is capable of storing the image data for at least one page, in the image forming apparatus,

ii) making a judgment as to whether the image data for predetermined pages are or are not capable of being stored in a free storage area of the storage section of the image forming apparatus,

iii) controlling the outputting of the print information such that:

a) in cases where it has been judged that the image data for the predetermined pages are capable of being stored in the free storage area of the storage section of the image forming apparatus, the image data for the predetermined pages are outputted from the print control apparatus into the storage section of the image forming apparatus and stored in the storage section,

b) the image data for the predetermined pages, which image data have thus been stored in the storage section of the image forming apparatus, are held in the storage section until the stored image data for the predetermined pages have been utilized for the formation of the image represented by the image information, which image formation is iterated the number of times equal to the number of the plurality of the copies, and

c) the image data for the remaining pages, which remaining pages are other than the predetermined pages, are outputted from the print control apparatus into the image forming apparatus and in the order of the pages, the outputting of the image data for the remaining pages from the print control apparatus into the image forming apparatus being iterated the number of times, which is equal to the number of the plurality of the copies, and

iv) controlling the image forming apparatus such that the image forming apparatus iterates an image forming process the number of times, which is equal to the number of the plurality of the copies, the image forming process comprising the reading of the image data for the predetermined pages, which image data are held in the storage section of the image forming apparatus, the acceptance of the image data for the remaining pages, which image data are outputted from the print control apparatus, and the formation of the image represented by the image information, which is composed of the image data for the predetermined pages having been read from the storage section of the image forming apparatus and the image data for the remaining pages having been accepted from the print control apparatus.

In the image forming method in accordance with the present invention, the judgment as to whether the image data for the predetermined pages are or are not capable of being stored in the free storage area of the storage section of the image forming apparatus may be made in the manner described below. Specifically, for example, information representing the data quantity of the image data for the predetermined pages may be outputted into the image forming apparatus. Also, a signal, which represents whether the data quantity of the image data for the predetermined pages is or is not capable of being stored in the free storage area of the storage section of the image forming apparatus, may be outputted from the image forming apparatus. The signal outputted from the image forming apparatus may be received, and the judgment as to whether the image data for the predetermined pages are or are not capable of being stored in the free storage area of the storage section of the image forming apparatus may be made in accordance with the received signal. Alternatively, information representing the free storage capacity of the storage section of the image forming apparatus may be received from the image forming apparatus, the free storage capacity of the storage section and the data quantity of the image data for the predetermined pages may be compared with each other, and the judgment as to whether the image data for the predetermined pages are or are not capable of being stored in the free storage area of the storage section of the image forming apparatus may be made in accordance with the result of the comparison.

As a data format of the image data described above, a data format appropriate for the constitution of the print control apparatus and the constitution of the image forming apparatus may be employed. For example, as the image data outputted from the print control apparatus into the image forming apparatus, bit map data may be utilized.

The image forming method in accordance with the present invention may be modified such that a judgment is made as to whether the image data for even-numbered pages or odd-numbered pages are or are not capable of being stored in the free storage area of the storage section of the image forming apparatus, the outputting of the print information is controlled such that:

a) in cases where it has been judged that the image data for the even-numbered pages or the odd-numbered pages are capable of being stored in the free storage area of the storage section of the image forming apparatus, the image data for the even-numbered pages or the odd-numbered pages are outputted from the print control apparatus into the storage section of the image forming apparatus and stored in the storage section,

b) the image data for the even-numbered pages or the odd-numbered pages, which image data have thus been stored in the storage section of the image forming apparatus, are held in the storage section until the stored image data for the even-numbered pages or the odd-numbered pages have been utilized for the formation of the image represented by the image information, which image formation is iterated the number of times equal to the number or the plurality of the copies, and

c) the image data for the remaining pages, which remaining pages are other than the even-numbered pages or the odd-numbered pages, are outputted from the print control apparatus into the image forming apparatus and in the order of the pages, the outputting of the image data for the remaining pages from the print control apparatus into the image forming apparatus being iterated the number of times, which is equal to the number of the plurality of the copies, and

the image forming apparatus is controlled such that the image forming apparatus iterates an image forming process the number of times, which is equal to the number of the plurality of the copies, the image forming process comprising the reading of the image data for the even-numbered pages or the odd-numbered pages, which image data are held in the storage section of the image forming apparatus, the acceptance of the image data for the remaining pages, which image data are outputted from the print control apparatus, and the formation of the image represented by the image information, which is composed of the image data for the even-numbered pages or the odd-numbered pages having been read from the storage section of the image forming apparatus and the image data for the remaining pages having been accepted from the print control apparatus.

The present invention also provides an image forming system, wherein a print control apparatus accepts an input of print information containing image information constituted of image data for a plurality of pages and outputs the image data for each of the pages, which image data constitutes the image information, in accordance with the print information, and an image forming apparatus iterates formation of an image represented by the image information a number of times equal to the number of a plurality of copies, the formation of the image being iterated in accordance with the image data having been outputted from the print control apparatus, the system comprising:

i) a storage section, which is located in the image forming apparatus and is capable of storing the image data for at least one page,

ii) a free storage capacity recognizing section for making a judgment as to whether the image data for predetermined pages are or are not capable of being stored in a free storage area of the storage section of the image forming apparatus,

iii) print information output controlling means for controlling the outputting of the print information such that:

a) in cases where it has been judged by the free storage capacity recognizing section that the image data for the predetermined pages are capable of being stored in the free storage area of the storage section of the image forming apparatus, the image data for the predetermined pages are outputted from the print control apparatus into the storage section of the image forming apparatus and stored in the storage section,

b) the image data for the predetermined pages, which image data have thus been stored in the storage section of the image forming apparatus, are held in the storage section until the stored image data for the predetermined pages have been utilized for the formation of the image represented by the image information, which image formation is iterated the number of times equal to the number of the plurality of the copies, and

c) the image data for the remaining pages, which remaining pages are other than the predetermined pages, are outputted from the print control apparatus into the image forming apparatus and in the order of the pages, the outputting of the image data for the remaining pages from the print control apparatus into the image forming apparatus being iterated the number of times, which is equal to the number of the plurality of the copies, and

iv) image formation controlling means for controlling the image forming apparatus such that the image forming apparatus iterates an image forming process the number of times, which is equal to the number of the plurality of the copies, the image forming process comprising the reading of the image data for the predetermined pages, which image data are held in the storage section of the image forming apparatus, the acceptance of the image data for the remaining pages, which image data are outputted from the print control apparatus, and the formation of the image represented by the image information, which is composed of the image data for the predetermined pages having been read from the storage section of the image forming apparatus and the image data for the remaining pages having been accepted from the print control apparatus.

In the image forming system in accordance with the present invention, with the free storage capacity recognizing section, the judgment as to whether the image data for the predetermined pages are or are not capable of being stored in the free storage area of the storage section of the image forming apparatus may be made in the manner described below. Specifically, for example, information representing the data quantity of the image data for the predetermined pages may be outputted from the free storage capacity recognizing section into the image forming apparatus. Also, a signal, which represents whether the data quantity of the image data for the predetermined pages is or is not capable of being stored in the free storage area of the storage section of the image forming apparatus, may be outputted from the image forming apparatus. The signal outputted from the image forming apparatus may be received by the free storage capacity recognizing section, and the judgment as to whether the image data for the predetermined pages are or are not capable of being stored in the free storage area of the storage section of the image forming apparatus may be made by the free storage capacity recognizing section in accordance with the received signal. Alternatively, information representing the free storage capacity of the storage section of the image forming apparatus may be received by the free storage capacity recognizing section and from the image forming apparatus, the free storage capacity of the storage section and the data quantity of the image data for the predetermined pages may be compared with each other by the free storage capacity recognizing section, and the judgment as to whether the image data for the predetermined pages are or are not capable of being stored in the free storage area of the storage section of the image forming apparatus may be made by the free storage capacity recognizing section and in accordance with the result of the comparison.

The image forming system in accordance with the present invention may be modified such that the free storage capacity recognizing section makes a judgment as to whether the image data for even-numbered pages or odd-numbered pages are or are not capable of being stored in the free storage area of the storage section of the image forming apparatus, the print information output controlling means controls the outputting of the print information such that:

a) in cases where it has been judged by the free storage capacity recognizing section that the image data for the even-numbered pages or the odd-numbered pages are capable of being stored in the free storage area of the storage section of the image forming apparatus, the image data for the even-numbered pages or the odd-numbered pages are outputted from the print control apparatus into the storage section of the image forming apparatus and stored in the storage section,

b) the image data for the even-numbered pages or the odd-numbered pages, which image data have thus been stored in the storage section of the image forming apparatus, are held in the storage section until the stored image data for the even-numbered pages or the odd-numbered pages have been utilized for the formation of the image represented by the image information, which image formation is iterated the number of times equal to the number of the plurality of the copies, and

c) the image data for the remaining pages, which remaining pages are other than the even-numbered pages or the odd-numbered pages, are outputted from the print control apparatus into the image forming apparatus and in the order of the pages, the outputting of the image data for the remaining pages from the print control apparatus into the image forming apparatus being iterated the number of times, which is equal to the number of the plurality of the copies, and the image formation controlling means controls the image forming apparatus such that the image forming apparatus iterates an image forming process the number of times, which is equal to the number of the plurality of the copies, the image forming process comprising the reading of the image data for the even-numbered pages or the odd-numbered pages, which image data are held in the storage section of the image forming apparatus, the acceptance of the image data for the remaining pages, which image data are outputted from the print control apparatus, and the formation of the image represented by the image information, which is composed of the image data for the even-numbered pages or the odd-numbered pages having been read from the storage section of the image forming apparatus and the image data for the remaining pages having been accepted from the print control apparatus.

The present invention further provides an image forming apparatus for use in the image forming system in accordance with the present invention, the apparatus comprising:

i) the storage section, which is capable of storing the image data for at least one page, and

ii) the image formation controlling means for controlling such that the image forming process is iterated the number of times, which is equal to the number of the plurality of the copies, the image forming process comprising the reading of the image data for the predetermined pages, which image data are held in the storage section of the image forming apparatus, the acceptance of the image data for the remaining pages, which image data are outputted from the print control apparatus, and the formation of the image represented by the image information, which is composed of the image data for the predetermined pages having been read from the storage section of the image forming apparatus and the image data for the remaining pages having been accepted from the print control apparatus.

The image forming apparatus in accordance with the present invention may be modified such that the image data for the predetermined pages are the image data for even-numbered pages or the image data for odd-numbered pages.

With the image forming method and system and the image forming apparatus in accordance with the present invention, the storage section, which is capable of storing the image data for at least one page, is located in the image forming apparatus. Also, the outputting of the print information is controlled such that: (a) in cases where it has been judged that the image data for the predetermined pages are capable of being stored in the free storage area of the storage section of the image forming apparatus, the image data for the predetermined pages are outputted from the print control apparatus into the storage section of the image forming apparatus and stored in the storage section, (b) the image data for the predetermined pages, which image data have thus been stored in the storage section of the image forming apparatus, are held in the storage section until the stored image data for the predetermined pages have been utilized for the formation of the image represented by the image information, which image formation is iterated the number of times equal to the number of the plurality of the copies, and (c) the image data for the remaining pages, which remaining pages are other than the predetermined pages, are outputted from the print control apparatus into the image forming apparatus and in the order of the pages, the outputting of the image data for the remaining pages from the print control apparatus into the image forming apparatus being iterated the number of times, which is equal to the number of the plurality of the copies. Further, the image forming apparatus is controlled such that the image forming apparatus iterates the image forming process the number of times, which is equal to the number of the plurality of the copies, the image forming process comprising the reading of the image data for the predetermined pages, which image data are held in the storage section of the image forming apparatus, the acceptance of the image data for the remaining pages, which image data are outputted from the print control apparatus, and the formation of the image represented by the image information, which is composed of the image data for the predetermined pages having been read from the storage section of the image forming apparatus and the image data for the remaining pages having been accepted from the print control apparatus. The image data for the predetermined pages, which image data are held in the storage section of the image forming apparatus, are thus read from the storage section the number of times, which is equal to the number of the plurality of the copies, and are utilized for the formation of the image represented by the image information, which image formation is iterated the number of times equal to the number of the plurality of the copies. Therefore, the number of times of the image data transfer from the print control apparatus into the image forming apparatus is capable of being kept small, and the time required to perform the image data transfer is capable of being kept short. Accordingly, the efficiency, with which the processing for the image formation is performed by the print control apparatus and the image forming apparatus, is capable of being enhanced.

With the modifications of the image forming method and system and the image forming apparatus in accordance with the present invention, the outputting of the print information is controlled such that: (a) in cases where it has been judged that the image data for the even-numbered pages or the odd-numbered pages are capable of being stored in the free storage area of the storage section of the image forming apparatus, the image data for the even-numbered pages or the odd-numbered pages are outputted from the print control apparatus into the storage section of the image forming apparatus and stored in the storage section, (b) the image data for the even-numbered pages or the odd-numbered pages, which image data have thus been stored in the storage section of the image forming apparatus, are held in the storage section until the stored image data for the even-numbered pages or the odd-numbered pages have been utilized for the formation of the image represented by the image information, which image formation is iterated the number of times equal to the number of the plurality of the copies, and (c) the image data for the remaining pages, which remaining pages are other than the even-numbered pages or the odd-numbered pages, are outputted from the print control apparatus into the image forming apparatus and in the order of the pages, the outputting of the image data for the remaining pages from the print control apparatus into the image forming apparatus being iterated the number of times, which is equal to the number of the plurality of the copies. Also, the image forming apparatus is controlled such that the image forming apparatus iterates the image forming process the number of times, which is equal to the number of the plurality of the copies, the image forming process comprising the reading of the image data for the even-numbered pages or the odd-numbered pages, which image data are held in the storage section of the image forming apparatus, the acceptance of the image data for the remaining pages, which image data are outputted from the print control apparatus, and the formation of the image represented by the image information, which is composed of the image data for the even-numbered pages or the odd-numbered pages having been read from the storage section of the image forming apparatus and the image data for the remaining pages having been accepted from the print control apparatus. With the modifications of the image forming method and system and the image forming apparatus in accordance with the present invention, the reading of the image data for the even-numbered pages or the odd-numbered pages from the storage section of the image forming apparatus and the acceptance of the image data for the remaining pages from the print control apparatus are capable of being performed alternately. Therefore, the efficiency, with which the processing for the image formation is performed, is capable of being enhanced even further,

### BRIEF DESCRIPTION OF THE DRAWINGS

FIG. 1 is a schematic view showing a printer system, in which an embodiment of the image forming system in accordance with the present invention is employed,

FIG. 2 is a block diagram showing a print control apparatus and a printer, which constitute the printer system of FIG. 1,

FIG. 3 is a flow chart showing how the printer system of FIG. 1 operates,

FIG. 4 is a flowchart showing how the printer system of FIG. 1 operates,

FIG. 5 is a flow chart showing how the printer system of FIG. 1 operates,

FIG. 6 is a flow chart showing how the printer system of FIG. 1 operates,

FIG. 7 is an explanatory view showing how a conventional printer system operates,

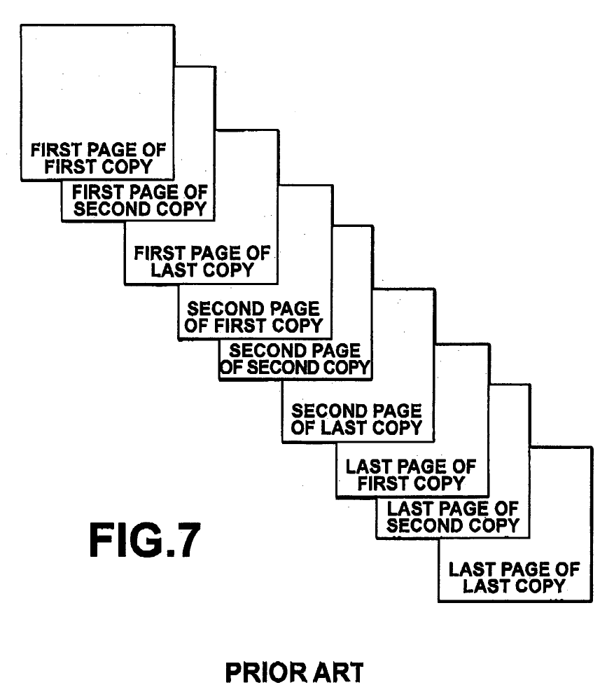

FIG. 8 is an explanatory view showing how a conventional printer system operates, and

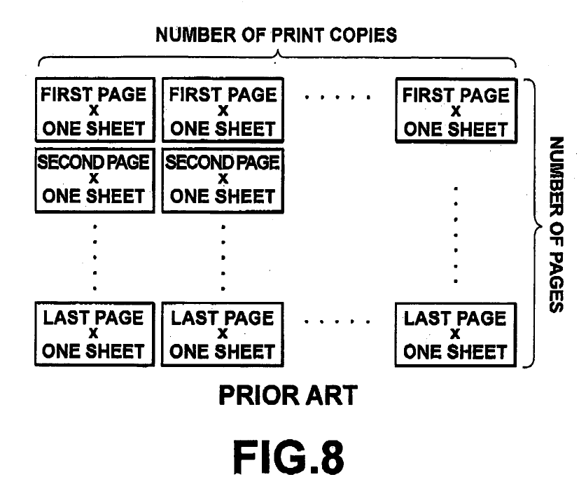

FIG. 9 is an explanatory view showing how the conventional printer system operates,

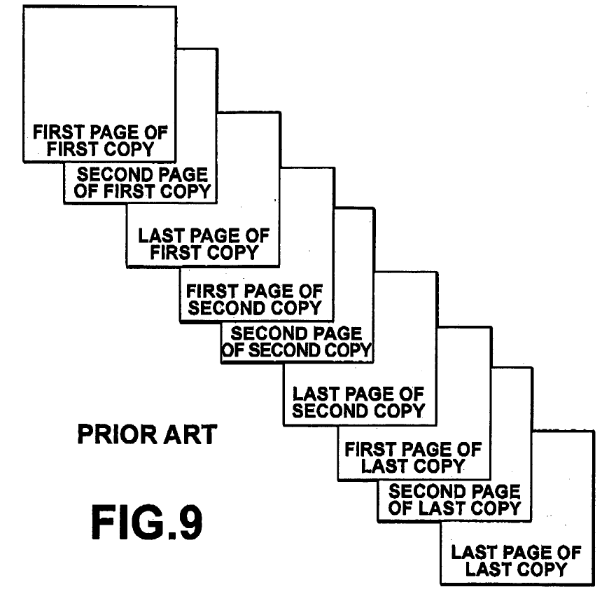

### DESCRIPTION OF THE PREFERRED EMBODIMENTS

The present invention will hereinbelow be described in further detail with reference to the accompanying drawings.

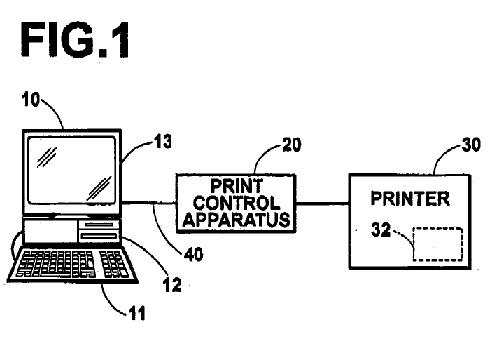

A printer system, in which an embodiment of the image forming system in accordance with the present invention is employed, will be described hereinbelow. FIG. 1 is a schematic view showing a printer system, in which an embodiment of the image forming system in accordance with the present invention is employed.

With reference to FIG. 1, the printer system comprises a computer 10 provided with a printer driver for outputting print information. The print information contains image information, which is constituted of image data for a plurality of pages, and print instructing information for instructing the printing of a plurality of copies of the image, which is represented by the image information. The printer system also comprises a print control apparatus 20 for outputting the image data for each of the pages, which image data constitutes the image information, in accordance with the print information, which has been outputted from the computer 10. The printer system further comprises a printer 30 for performing the printing in accordance with the image data having been outputted from the print control apparatus 20.

The computer 10 comprises a keyboard 11, from which the image information is capable of being inputted and edited. The computer 10 also comprises a main body 12, in which the printer driver has been installed. The computer 10 further comprises a display section 13 for displaying the image information, a print setting screen, from which the number of sheets to be printed and the number of the print copies are capable of being specified, and the like.

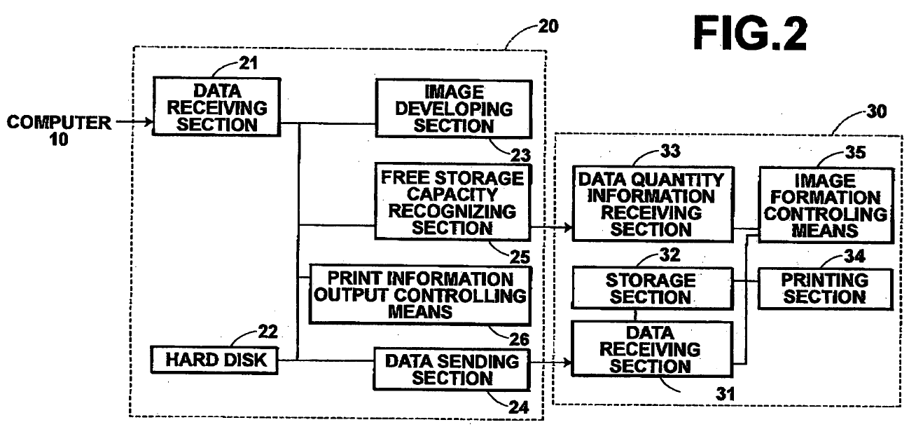

As illustrated in FIG. 2, the print control apparatus 20 comprises a data receiving section 21 for accepting the input of the print information having been outputted from the computer 10. The print control apparatus 20 also comprises a hard disk 22 for storing the image data, which have been received by the data receiving section 211, and bit map data having been developed by an image developing section 23, which will be described below. The print control apparatus 20 further comprises the image developing section 23 for developing the image data, which have been received by the data receiving section 21, into the bit map data. The print control apparatus 20 still further comprises a data sending section 24 for outputting the bit map data, which have been developed by the image developing section 23, into the printer 30. The print control apparatus 20 also comprises a free storage capacity recognizing section 25 for making a judgment as to whether the bit map data for predetermined pages are or are not capable of being stored in a free storage area of a storage section 32 of the printer 30, which storage section will be described later. The print control apparatus 20 further comprises print information output controlling means 26 for controlling the outputting of the print information such that: (a) in cases where it has been judged by the free storage capacity recognizing section 25 that the bit map data for the predetermined pages are capable of being stored in the free storage area of the storage section 32 of the printer 30, the bit map data for the predetermined pages are outputted from the print control apparatus 20 into the storage section 32 of the printer 30 and stored in the storage section 32, (b) the bit map data for the predetermined pages, which bit map data have thus been stored in the storage section 32 or the printer 30, are held in the storage section 32 until the stored bit map data for the predetermined pages have been utilized for the formation of the image represented by the image information, which image formation is iterated the number of times equal to the number of the plurality of the copies, and (c) the bit map data for the remaining pages, which remaining pages are other than the predetermined pages, are outputted from the print control apparatus 20 into the printer 30 and in the order of the pages, the outputting of the bit map data for the remaining pages from the print control apparatus 20 into the printer 30 being iterated the number of times, which is equal to the number of the plurality of the copies.

The printer 30 comprises a data receiving section 31 for receiving the bit map data, which have been outputted from the data sending section 24 of the print control apparatus 20. The printer 30 also comprises the storage section 32, which is capable of storing the bit map data for at least one page, which bit map data has been received by the data receiving section 31. The printer 30 further comprises a data quantity information receiving section 33 for receiving information, which represents the data quantity of the bit map data for the predetermined pages, from the free storage capacity recognizing section 25 of the print control apparatus 20, comparing the data quantity of the bit map data for the predetermined pages and the free storage capacity of the storage section 32 of the printer 30, and sending a signal, which represents whether the bit map data for the predetermined pages are or are not capable of being stored in the free storage area of the storage section 32 of the printer 30, into the free storage capacity recognizing section 25. The printer 30 still further comprises a printing section 34 for performing the printing in accordance with the bit map data, which have been received by the data receiving section 31, and the bit map data, which are held in the storage section 32. The printer 30 also comprises image formation controlling means 35 for controlling the receiving of the bit map data by the data receiving section 31, the reading of the bit map data from the storage section 32, and the printing performed by the printing section 34. The printer 30 may be a printer utilizing an ink jet printing technique. Alternatively, the printer 30 may be a printer utilizing a toner printing technique. Also, as the storage section 32, a semiconductor memory enabling quick readout should preferably be utilized.

A cable 40 illustrated in FIG. 1 may be an ordinary wire cable or a communication cable for LAN, or the like. Alternatively, in lieu of the cable 40, a radio LAN communication technique may be employed.

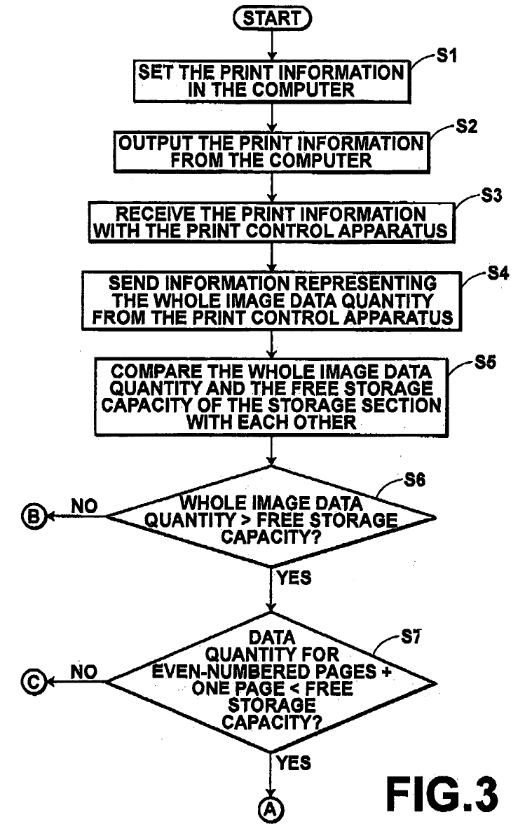

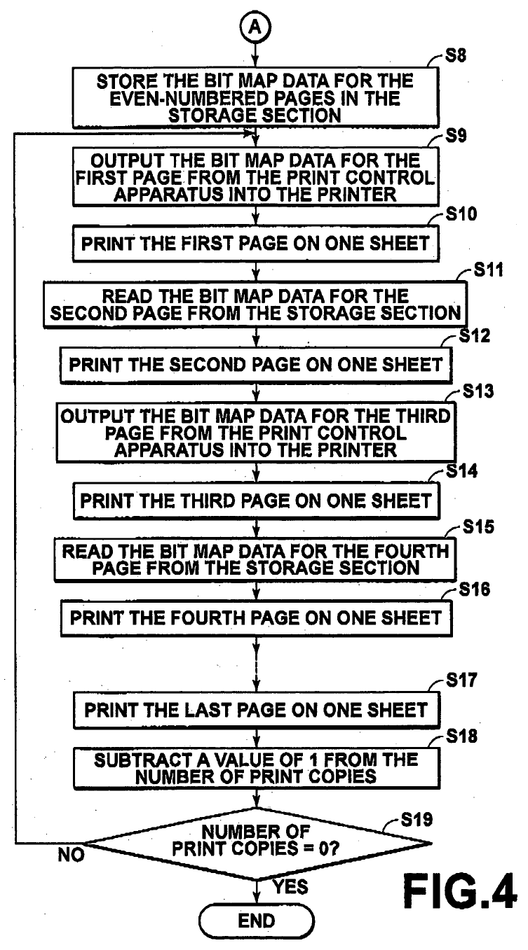

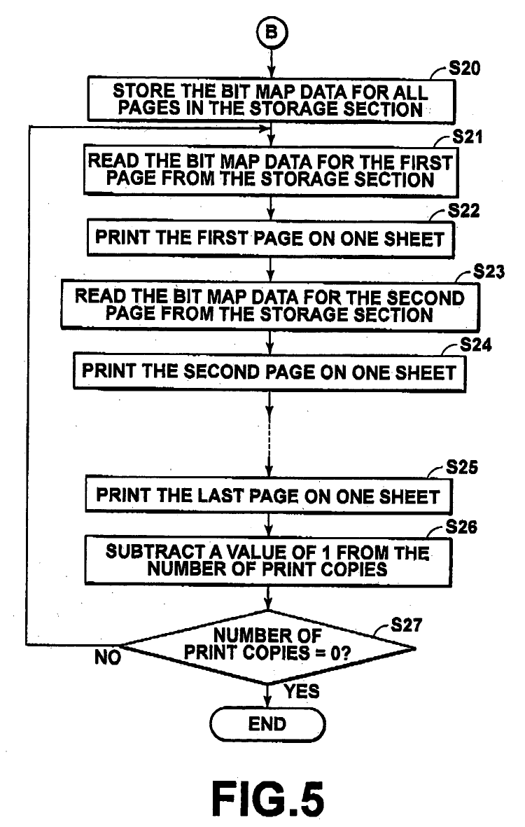

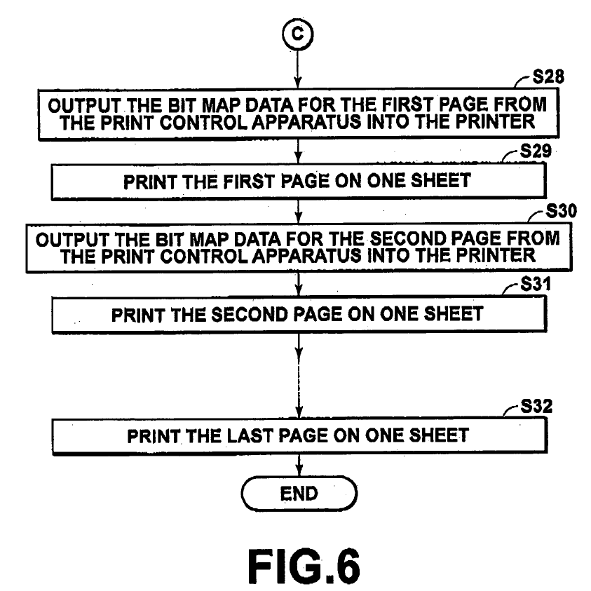

How the printer system operates will be described hereinbelow with reference to FIG. 3, FIG. 4, FIG. 5, and FIG. 6.

Firstly, the image information, which is constituted of the image data for the plurality of the pages, is edited with the computer 10. Thereafter, in a step S1, with the printer driver of the computer 10, the print setting screen is displayed on the display section 13. Also, from the print setting screen, the print instructing information for specifying the pages to be printed, the number of the plurality of the copies, and the like, is inputted by the operator by use of the keyboard 11.

After the print instructing information has been set from the print setting screen in the manner described above, in a step S2, the print information, which contains the image information and the print instructing information, is outputted from the printer driver of the computer 10 into the print control apparatus 20. In a step S3, the print information, which has been outputted from the computer 10, is received by the data receiving section 21 of the print control apparatus 20, and the image data for each of the pages, which image data is contained in the print information, is stored on the hard disk 22. Also, the image data for each of the pages, which image data is contained in the print information, is outputted from the data receiving section 21 into the image developing section 23. After the image data has been developed by the image developing section 23 into the bit map data, the bit map data is stored on the hard disk 22. Further, the print instructing information for specifying the number of the plurality of the copies, and the like, which print instructing information is contained in the print information, is outputted from the data receiving section 21 into the print information output controlling means 26 and stored in the print information output controlling means 26.

Thereafter, in a step S4, the whole image data quantity of the bit map data, which have been stored on the hard disk 22, is calculated by the free storage capacity recognizing section 25 of the print control apparatus 20, and the information representing the whole image data quantity is outputted from the free storage capacity recognizing section 25 into the data quantity information receiving section 33 of the printer 30. Also, in a step S5, the data quantity information receiving section 33 of the printer 30 receives the information representing the whole image data quantity and compares the whole image data quantity and the free storage capacity of the storage section 32. In a step S6, the data quantity information receiving section 33 of the printer 30 makes a judgment as to whether the whole image data quantity is or is not larger than the free storage capacity of the storage section 32. In cases where it has been judged by the data quantity information receiving section 33 in the step S6 that the whole image data quantity is larger than the free storage capacity of the storage section 32, the data quantity information receiving section 33 outputs a signal, which represents that the whole image data quantity is larger than the free storage capacity of the storage section 32, into the free storage capacity recognizing section 25 of the print control apparatus 20. In accordance with the received signal, which represents that the whole image data quantity is larger than the free storage capacity of the storage section 32, the free storage capacity recognizing section 25 of the print control apparatus 20 calculates the data quantity of the bit map data for the even-numbered pages, which bit map data are contained in the bit map data having been stored on the hard disk 22. The free storage capacity recognizing section 25 of the print control apparatus 20 then calculates an addition data quantity, which is obtained by adding the data quantity of the bit map data for one page to the data quantity of the bit map data for the even-numbered pages. Also, the free storage capacity recognizing section 25 of the print control apparatus 20 outputs the information, which represents the thus calculated addition data quantity, into the data quantity information receiving section 33 of the printer 30. In this embodiment, the maximum data quantity capable of being printed on a sheet of printing paper having a predetermined size is set as the data quantity of the bit map data for one page, which data quantity is added to the data quantity of the bit map data for the even-numbered pages in the manner described above.

In a step S7, the data quantity information receiving section 33 compares the addition data quantity, which is represented by the received information, and the free storage capacity of the storage section 32 with each other. In cases where it has been judged by the data quantity information receiving section 33 in the step S7 that the free storage capacity of the storage section 32 is larger than the addition data quantity, the data quantity information receiving section 33 outputs a signal, which represents that the free storage capacity of the storage section 32 is larger than the addition data quantity, into the free storage capacity recognizing section 25 of the print control apparatus 20. In this embodiment, as described above, the addition data quantity, which is obtained by adding the data quantity of the bit map data for one page to the data quantity of the bit map data for the even-numbered pages, and the free storage capacity of the storage section 32 are compared with each other. The data quantity of the bit map data for one page is thus added to the data quantity of the bit map data for the even-numbered pages, such that the storage capacity for temporarily storing the bit map data having been outputted from the print control-apparatus 20 is capable of being obtained. In cases where the bit map data having been outputted from the print control apparatus 20 is not temporarily stored in the storage section 32 and is outputted directly into the printing section 34, the data quantity of the bit map data for one page need not necessarily be added to the data quantity of the bit map data for the even-numbered pages. In such cases, in the data quantity information receiving section 33, the data quantity of the bit map data for the even-numbered pages and the free storage capacity of the storage section 32 may be compared with each other.

Also, in accordance with the received signal, which represents that the free storage capacity of the storage section 32 is larger than the addition data quantity, the free storage capacity recognizing section 25 outputs a signal into the print information output controlling means 26. In accordance with the signal received from the free storage capacity recognizing section 25, the print information output controlling means 26 controls such that the bit map data for the even-numbered pages are read from the hard disk 22 and outputted into the data sending section 24. Further, print information output controlling means 26 controls such that the bit map data for the even-numbered pages and the information, which represents the number of the print copies, are outputted from the data sending section 24 into the data receiving section 31 of the printer 30. Furthermore, in a step S8, the bit map data for the even-numbered pages are outputted from the data receiving section 31 of the printer 30 into the storage section 32 and stored in the storage section 32. Also, the information, which represents the number of the print copies, is outputted from the data receiving section 31 of the printer 30 into the image formation controlling means 35 of the printer 30 and stored in the image formation controlling means 35. The print information output controlling means 26 outputs a control signal into the storage section 32 in order to control such that the bit map data for the even-numbered pages, which bit map data have been stored in the storage section 32 of the printer 30, are held in the storage section 32 until the stored bit map data for the even-numbered pages have been utilized for the formation of the image represented by the image information, which image formation is iterated the number of times equal to the number of the plurality of the print copies.

Thereafter, in a step S9, the print information output controlling means 26 of the print control apparatus 20 controls such that the bit map data for a first page is read from the hard disk 22 and outputted from the data sending section 24 into the printer 30. The image formation controlling means 35 of the printer 30 controls such that the bit map data for the first page, which bit map data has been outputted from the data sending section 24, is received by the data receiving section 31 and outputted from the data receiving section 31 into printing section 34. In a step S10, the printing of the first page is performed by the printing section 34 and in accordance with the bit map data for the first page, which bit map data has been inputted into the printing section 34. In a step S11, the image formation controlling means 35 then controls such that the bit map data for a second page, which bit map data has been stored in the storage section 32 of the printer 30, is read from the storage section 32. Also, the image formation controlling means 35 controls such that the bit map data for the second page, which bit map data has been read from the storage section 32, is outputted into the printing section 34. In a step S12, the printing of the second page is performed by the printing section 34 and in accordance with the bit map data for the second page, which bit map data has been inputted into the printing section 34.

Thereafter, in a step S13, the print information output controlling means 26 of the print control apparatus 20 controls such that the bit map data for a third page is read from the hard disk 22 and outputted from the data sending section 24 into the printer 30. The image formation controlling means 35 of the printer 30 controls such that the bit map data for the third page, which bit map data has been outputted from the data sending section 24, is received by the data receiving section 31 and outputted from the data receiving section 31 into printing section 34. In a step S14, the printing of the third page is performed by the printing section 34 and in accordance with the bit map data for the third page, which bit map data has been inputted into the printing section 34. In a step S15, the image formation controlling means 35 then controls such that the bit map data for a fourth page, which bit map data has been stored in the storage section 32 of the printer 30, is read from the storage section 32. Also, the image formation controlling means 35 controls such that the bit map data for the fourth page, which bit map data has been read from the storage section 32, is outputted into the printing section 34. In a step S16, the printing of the fourth page is performed by the printing section 34 and in accordance with the bit map data for the fourth page, which bit map data has been inputted into the printing section 34.

In the manner described above, the printing of the odd-numbered page, which printing is performed in accordance with the bit map data having been outputted from the print control apparatus 20, and the printing of the even-numbered page, which printing is performed in accordance with the bit map data having been read from the storage section 32 of the printer 30, are iterated alternately. In a step S17, the printing of the last page is performed. After the printing of the last page, which constitutes a first print copy, is completed in the manner described above, in a step S18, a value of 1 is subtracted from the number of the print copies, which number is represented by the information having been stored in the image formation controlling means 35 of the printer 30. Also, in a step S19, a judgment is made as to whether the number of the print copies, which number results from the subtraction, is or is not equal to 0. In cases where it has been judged that the number of the print copies, which number results from the subtraction, is equal to 0, the processing is finished in this stage. In cases where it has been judged that the number of the print copies, which number results from the subtraction, is not equal to 0, the processing ranging from the step S9 to the step S18 is iterated until the number of the print copies, which number results from the subtraction, becomes equal to 0. The processing is performed in the manner described above, and the image represented by the image information, which is constituted of the image data for the plurality of the pages, is printed in units of copy.

In cases where it has been judged by the data quantity information receiving section 33 in the step S6 that the free storage capacity of the storage section 32 is equal to at least the whole image data quantity, the processing is performed in the manner described below. Specifically, the data quantity information receiving section 33 outputs a signal, which represents that the free storage capacity of the storage section 32 is equal to at least the whole image data quantity, into the free storage capacity recognizing section 25 of the print control apparatus 20. In accordance with the received signal, which represents that the free storage capacity of the storage section 32 is equal to at least the whole image data quantity, the free storage capacity recognizing section 25 outputs a signal into the print information output controlling means 26. In accordance with the signal received from the free storage capacity recognizing section 25, the print information output controlling means 26 controls such that the bit map data for all of the pages are read from the hard disk 22 and outputted into the data sending section 24. Further, print information output controlling means 26 controls such that the bit map data for all of the pages and the information, which represents the number of the print copies, are outputted from the data sending section 24 into the data receiving section 31 of the printer 30. Furthermore, in a step S20, the bit map data for all of the pages are outputted from the data receiving section 31 of the printer 30 into the storage section 32 and stored in the storage section 32. Also, the information, which represents the number of the print copies, is outputted from the data receiving section 31 of the printer 30 into the image formation controlling means 35 of the printer 30 and stored in the image formation controlling means 35. The print information output controlling means 26 outputs a control signal into the storage section 32 in order to control such that the bit map data for all of the pages, which bit map data have been stored in the storage section 32 of the printer 30, are held in the storage section 32 until the stored bit map data for all of the pages have been utilized for the formation of the image represented by the image information, which image formation is iterated the number of times equal to the number of the plurality of the print copies. Also, the print information output controlling means 26 outputs a signal, which represents that the bit map data for all of the pages have been sent, into the image formation controlling means 35 of the printer 30.

After the image formation controlling means 35 of the printer 30 has received the signal, which represents that the bit map data for all of the pages have been sent, from the print information output controlling means 26, in a step S21, the image formation controlling means 35 of the printer 30 controls such that the bit map data for the first page is read from the storage section 32. The image formation controlling means 35 of the printer 30 also controls such that the bitmap data for the first page, which bit map data has been read from the storage section 32, is outputted into the printing section 34. Also, in a step S22, the printing of the first page is performed by the printing section 34 and in accordance with the bit map data for the first page, which bit map data has been inputted into the printing section 34 in a step S23, the image formation controlling means 35 then controls such that the bit map data for the second page, which bit map data has been stored in the storage section 32 of the printer 30, is read from the storage section 32. Also, the image formation controlling means 35 controls such that the bit map data for the second page, which bit map data has been read from the storage section 32, is outputted into the printing section 34. In a step S24, the printing of the second page is performed by the printing section 34 and in accordance with the bit map data for the second page, which bit map data has been inputted into the printing section 34.

In the manner described above, the processing for performing the printing in accordance with the bit map data, which have been read in the order of the pages from the storage section 32 of the printer 30, is iterated. In a step S25, the printing of the last page is performed. After the printing of the last page, which constitutes the first print copy, is completed in the manner described above, in a step S26, a value of 1 is subtracted from the number of the print copies, which number is represented by the information having been stored in the image formation controlling means 35 of the printer 30. Also, in a step S27, a judgment is made as to whether the number of the print copies, which number results from the subtraction, is or is not equal to 0. In cases where it has been judged that the number of the print copies, which number results from the subtraction, is equal to 0, the processing is finished in this stage. In cases where it has been judged that the number of the print copies, which number results from the subtraction, is not equal to 0, the processing ranging from the step S21 to the step S26 is iterated until the number of the print copies, which number results from the subtraction, becomes equal to 0. The processing is performed in the manner described above, and the image represented by the image information, which is constituted of the image data for the plurality of the pages, is printed in units of copy.

In cases where it has been judged by the data quantity information receiving section 33 in the step S6 that the free storage capacity of the storage section 32 is smaller than the whole image data quantity, and it has then been judged by the data quantity information receiving section 33 in the step S7 that the addition data quantity, which is obtained by adding the data quantity of the bit map data for one page to the data quantity of the bit map data for the even-numbered pages, is larger than the free storage capacity of the storage section 32, the processing is performed in the manner described below. Specifically, in a step S28, the print information output controlling means 26 of the print control apparatus 20 controls such that the bit map data for the first page is outputted from the hard disk 22 of the print control apparatus 20 into the printer 30. The bit map data for the first page, which bit map data has been outputted from the hard disk 22, is received by the data receiving section 31 of the printer 30 and temporarily stored in the storage section 32. Also, the image formation controlling means 35 of the printer 30 controls such that the bit map data for the first page is read from the storage section 32 and outputted into the printing section 34. In a step S29, the printing of the first page is performed by the printing section 34 and in accordance with the bit map data for the first page, which bit map data has been inputted into the printing section 34. After the printing of the first page is completed, in a step S30, the print information output controlling means 26 of the print control apparatus 20 controls such that the bit map data for the second page is outputted from the hard disk 22 of the print control apparatus 20 into the printer 30. The bit map data for the second page, which bit map data has been outputted from the hard disk 22, is received by the data receiving section 31 of the printer 30 and temporarily stored in the storage section 32. Also, the image formation controlling means 35 of the printer 30 controls such that the bit map data for the second page is read from the storage section 32 and outputted into the printing section 34. In a step S31, the printing of the second page is performed by the printing section 34 and in accordance with the bit map data for the second page, which bit map data has been inputted into the printing section 34.

In the manner described above, the processing for performing the printing in accordance with the bit map data for each of the pages, which bit map data has been outputted from the print control apparatus 20, is iterated. In a step S32, the printing of the last page is performed. After the printing of the last page, which constitutes the first print copy, is completed in the manner described above, the bit map data for the first page, which constitutes a second print copy, is outputted from the print control apparatus 20. Also, in the same manner as that described above, the printing is performed until the printing of the last page, which constitutes the second print copy, is completed. The bit map data for each of the pages is thus outputted from the print control apparatus 20 in the order of the pages, and the outputting of the bit map data for each of the pages is iterated the number of times, which is equal to the number of the plurality of the copies. The image represented by the image information, which is constituted of the image data for the plurality of the pages, is thus printed in units of copy.

With the printer system described above, the storage section 32, which is capable of storing the bit map data for at least one page, is located in the printer 30. Also, the outputting of the print information is controlled such that: (a) in cases where it has been judged by the free storage capacity recognizing section 25 that the bitmap data for the even-numbered pages are capable of being stored in the free storage area of the storage section 32 of the printer 30, the bit map data for the even-numbered pages are outputted from the print control apparatus 20 into the storage section 32 of the printer 30 and stored in the storage section 32, (b) the bit map data for the even-numbered pages, which bit map data have thus been stored in the storage section 32 of the printer 30, are held in the storage section 32 until the stored bit map data for the even-numbered pages have been utilized for the formation of the image represented by the image information, which image formation is iterated the number of times equal to the number of the plurality of the copies, and (c) the bit map data for the odd-numbered pages are outputted from the print control apparatus 20 into the printer 30 and in the order of the pages, the outputting of the bit map data for the odd-numbered pages from the print control apparatus 20 into the printer 30 being iterated the number of times, which is equal to the number of the plurality of the copies. Further, the printer 30 is controlled such that the printer 30 iterates the image forming process the number of times, which is equal to the number of the plurality of the copies, the image forming process comprising the reading of the bit map data for the even-numbered pages, which bit map data are held in the storage section 32 of the printer 30, the acceptance of the bit map data for the odd-numbered pages, which bit map data are outputted from the print control apparatus 20, and the formation of the image represented by the image information, which is composed of the bit map data for the even-numbered pages having been read from the storage section 32 of the printer 30 and the bit map data for the odd-numbered pages having been accepted from the print control apparatus 20. The bit map data for the even-numbered pages, which bit map data are held in the storage section 32 of the printer 30, are thus read from the storage section 32 the number of times, which is equal to the number of the plurality of the copies, and are utilized for the formation of the image represented by the image information, which image formation is iterated the number of times equal to the number of the plurality of the copies. Therefore, the number of times of the bit map data transfer from the print control apparatus 20 into the printer 30 is capable of being kept small, and the time required to perform the bit map data transfer is capable of being kept short. Accordingly, the efficiency, with which the processing for the image formation is performed by the print control apparatus 20 and the printer 30, is capable of being enhanced.

In the embodiment described above, in the step S7, the data quantity information receiving section 33 compares the addition data quantity, which is obtained by adding the data quantity of the bit map data for one page to the data quantity of the bit map data for the even-numbered pages, and the free storage capacity of the storage section 32 with each other and makes the judgment as to whether the free storage capacity of the storage section 32 is or is not larger than the addition data quantity. However, the data quantity, which is compared with the free storage capacity of the storage section 32, need not necessarily be the addition data quantity, which is obtained by adding the data quantity of the bit map data for one page to the data quantity of the bit map data for the even-numbered pages. Specifically, alternatively, an addition data quantity, which is obtained by adding the data quantity of the bit map data for one page to the data quantity of the bit map data for the odd-numbered pages, and the free storage capacity of the storage section 32 may be compared with each other. Also, in cases where it has been judged that the free storage capacity of the storage section 32 is larger than the addition data quantity, which is obtained by adding the data quantity of the bit map data for one page to the data quantity of the bit map data for the odd-numbered pages, the bit map data for the odd-numbered pages may be stored and held in the free storage area of the storage section 32. Further, the printing of the image information may be performed through the reading of the bit map data for the odd-numbered pages, which bit map data are held in the storage section 32 of the printer 30, and the acceptance of the bit map data for the even-numbered pages, which bit map data are outputted from the print control apparatus 20. As another alternative, in lieu of the addition data quantity, which is obtained by adding the data quantity of the bit map data for one page to the data quantity of the bit map data for the even-numbered pages or the odd-numbered pages, the data quantity of the bit map data for predetermined pages, which have been set previously, may be compared with the free storage capacity of the storage section 32. Also, in cases where it has been judged that the free storage capacity of the storage section 32 is larger than the data quantity of the bit map data for the predetermined pages, the bit map data for the predetermined pages may be stored and held in the free storage area of the storage section 32. Further, the reading of the bit map data for the predetermined pages, which bit map data are held in the storage section 32 of the printer 30, and the acceptance of the bit map data for the remaining pages other than the predetermined pages described above, which bit map data are outputted from the print control apparatus 20, maybe performed in the order of the pages, and the printing of the image information may thus be performed.

Also, in the embodiment described above, in cases where it has been judged by the data quantity information receiving section 33 in the step S6 that the free storage capacity of the storage section 32 is smaller than the whole image data quantity, and it has then been judged by the data quantity information receiving section 33 in the step S7 that the addition data quantity, which is obtained by adding the data quantity of the bit map data for one page to the data quantity of the bit map data for the even-numbered pages, is larger than the free storage capacity of the storage section 32, the bit map data for each of the pages is successively outputted in the order of the pages from the print control apparatus 20 into the printer 30 and utilized for the printing. In such cases, alternatively, the data quantity, which is capable of being stored in the free storage area of the storage section 32 of the printer 30, or the corresponding number of pages may be confirmed by the free storage capacity recognizing section 25 of the print control apparatus 20. Also, in cases where the bit map data for at least one page is capable of being stored in the free storage area of the storage section 32 of the printer 30, the bit map data for the at least one page, which bit map data is capable of being stored in the free storage area of the storage section 32 of the printer 30, may be stored and held in the storage section 32. Further, the reading of the bit map data for the at least one page described above, which bit map data is held in the storage section 32 of the printer 30, and the acceptance of the bit map data for the remaining pages other than the at least one page described above, which bit map data are outputted from the print control apparatus 20, may be performed in the order of the pages, and the printing of the image information may thus be performed.

Further, in the embodiment described above, the judgment is made as to whether the whole image data quantity for all of the pages is or is not capable of being stored in the free storage area of the storage section 32, and the judgment is then made as to whether the data quantity for the even-numbered pages is or is not capable of being stored in the free storage area of the storage section 32. Alternatively, the data quantity, which is capable of being stored in the free storage area of the storage section 32 of the printer 30, or the corresponding number of pages may be confirmed by the free storage capacity recognizing section 25 of the print control apparatus 20. Also, in cases where the bit map data for at least one page is capable of being stored in the free storage area of the storage section 32 of the printer 30, the bit map data for the at least one page, which bit map data is capable of being stored in the free storage area of the storage section 32 of the printer 30, may be stored and held in the storage section 32. Further, the reading of the bit map data for the at least one page described above, which bit map data is held in the storage section 32 of the printer 30, and the acceptance of the bit map data for the remaining pages other than the at least one page described above, which bit map data are outputted from the print control apparatus 20, may be performed in the order or the pages, and the printing of the image information may thus be performed.

Furthermore, in the embodiment described above, the print information output controlling means 26 is located in the print control apparatus 20, and the image formation controlling means 35 is located in the printer 30. However, the print information output controlling means 26 need not necessarily be located in the print control apparatus 20, and the image formation controlling means 35 need not necessarily be located in the printer 30. Specifically, alternatively, the print information output controlling means 26 may be located as an independent device on the outside of the print control apparatus 20, or the image formation controlling means 35 may be located as an independent device on the outside of the printer 30. As another alternative, both the print information output controlling means 26 and the image formation controlling means 35 may be located in either one of the print control apparatus 20 and the printer 30. As a further alternative, part of the print information output controlling means 26 may be located in the printer 30, or part of the image formation controlling means 35 may be located in the print control apparatus 20.

What is claimed is:

1. An image forming method, wherein print information, which contains image information constituted of image data for a plurality of pages, is inputted into a print control apparatus, the image data for each of the pages, which image data constitutes the image information, is outputted from the print control apparatus and in accordance with the print information, and formation of an image represented by the image information is iterated a number of times equal to the number of a plurality of copies, the formation of the image being iterated by an image forming apparatus and in accordance with the image data having been outputted from the print control apparatus, the method comprising the steps of:
i) locating a storage section, which is capable of storing the image data for at least one page, in the image forming apparatus,
ii) making a judgment as to whether the image data for predetermined pages are or are not capable of being stored in a free storage area of the storage section of the image forming apparatus,
iii) controlling the outputting of the print information such that:
a) in cases where it has been judged that the image data for the predetermined pages are capable of being stored in the free storage area of the storage section of the image forming apparatus, the image data for the predetermined pages are outputted from the print control apparatus into the storage section of the image forming apparatus and stored in the storage section,
b) the image data for the predetermined pages, which image data have thus been stored in the storage section of the image forming apparatus, are held in the storage section until the stored image data for the predetermined pages have been utilized for the formation of the image represented by the image information, which image formation is iterated the number of times equal to the number of the plurality of the copies, and
c) the image data for the remaining pages, which remaining pages are other than the predetermined pages, are outputted from the print control apparatus into the image forming apparatus and in the order of the pages, the outputting of the image data for the remaining pages from the print control apparatus into the image forming apparatus being iterated the number of times, which is equal to the number of the plurality of the copies, and
iv) controlling the image forming apparatus such that the image forming apparatus iterates an image forming process the number of times, which is equal to the number of the plurality of the copies, the image forming process comprising the reading of the image data for the predetermined pages, which image data are held in the storage section of the image forming apparatus, the acceptance of the image data for the remaining pages, which image data are outputted from the print control apparatus, and the formation of the image represented by the image information, which is composed of the image data for the predetermined pages having been read from the storage section of the image forming apparatus and the image data for the remaining pages having been accepted from the print control apparatus.

2. An image forming method as defined in claim 1 wherein a judgment is made as to whether the image data for even-numbered pages or odd-numbered pages are or are not capable of being stored in the free storage area of the storage section of the image forming apparatus, the outputting of the print information is controlled such that:
a) in cases where it has been judged that the image data for the even-numbered pages or the odd-numbered pages are capable of being stored in the free storage area of the storage section of the image forming apparatus, the image data for the even-numbered pages or the odd-numbered pages are outputted from the print control apparatus into the storage section of the image forming apparatus and stored in the storage section,
b) the image data for the even-numbered pages or the odd-numbered pages, which image data have thus been stored in the storage section of the image forming apparatus, are held in the storage section until the stored image data for the even-numbered pages or the odd-numbered pages have been utilized for the formation of the image represented by the image information, which image formation is iterated the number of times equal to the number of the plurality of the copies, and
c) the image data for the remaining pages, which remaining pages are other than the even-numbered pages or the odd-numbered pages, are outputted from the print control apparatus into the image forming apparatus and in the order of the pages, the outputting of the image data for the remaining pages from the print control apparatus into the image forming apparatus being iterated the number of times, which is equal to the number of the plurality of the copies, and
the image forming apparatus is controlled such that the image forming apparatus iterates an image forming process the number of times, which is equal to the number of the plurality of the copies, the image forming process comprising the reading of the image data for the even-numbered pages or the odd-numbered pages, which image data are held in the storage section of the image forming apparatus, the acceptance of the image data for the remaining pages, which image data are outputted from the print control apparatus, and the formation of the image represented by the image information, which is composed of the image data for the even-numbered pages or the odd-numbered pages having been read from the storage section of the image forming apparatus and the image data for the remaining pages having been accepted from the print control apparatus.

3. An image forming system, wherein a print control apparatus accepts an input of print information containing image information constituted of image data for a plurality of pages and outputs the image data for each of the pages, which image data constitutes the image information, in accordance with the print information, and an image forming apparatus iterates formation of an image represented by the image information a number of times equal to the number of a plurality of copies, the formation of the image being iterated in accordance with the image data having been outputted from the print control apparatus, the system comprising:
i) a storage section, which is located in the image forming apparatus and is capable of storing the image data for at least one page,
ii) a free storage capacity recognizing section for making a judgment as to whether the image data for predetermined pages are or are not capable of being stored in a free storage area of the storage section of the image forming apparatus,
iii) print information output controlling means for controlling the outputting of the print information such that:
a) in cases where it has been judged by the free storage capacity recognizing section that the image data for the predetermined pages are capable of being stored in the free storage area of the storage section of the image forming apparatus, the image data for the predetermined pages are outputted from the print control apparatus into the storage section of the image forming apparatus and stored in the storage section,
b) the image data for the predetermined pages, which image data have thus been stored in the storage section of the image forming apparatus, are held in the storage section until the stored image data for the predetermined pages have been utilized for the formation of the image represented by the image information, which image formation is iterated the number of times equal to the number of the plurality of the copies, and
c) the image data for the remaining pages, which remaining pages are other than the predetermined pages, are outputted from the print control apparatus into the image forming apparatus and in the order of the pages, the outputting of the image data for the remaining pages from the print control apparatus into the image forming apparatus being iterated the number of times, which is equal to the number of the plurality of the copies, and
iv) image formation controlling means for controlling the image forming apparatus such that the image forming apparatus iterates an image forming process the number of times, which is equal to the number of the plurality of the copies, the image forming process comprising the reading of the image data for the predetermined pages, which image data are held in the storage section of the image forming apparatus, the acceptance of the image data for the remaining pages, which image data are outputted from the print control apparatus, and the formation of the image represented by the image information, which is composed of the image data for the predetermined pages having been read from the storage section of the image forming apparatus and the image data for the remaining pages having been accepted from the print control apparatus.

4. An image forming system as defined in claim 3 wherein the free storage capacity recognizing section makes a judgment as to whether the image data for even-numbered pages or odd-numbered pages are or are not capable of being stored in the free storage area of the storage section of the image forming apparatus,
the print information output controlling means controls the outputting of the print information such that:
a) in cases where it has been judged by the free storage capacity recognizing section that the image data for the even-numbered pages or the odd-numbered pages are capable of being stored in the free storage area of the storage section of the image forming apparatus, the image data for the even-numbered pages or the odd-numbered pages are outputted from the print control apparatus into the storage section of the image forming apparatus and stored in the storage section,
b) the image data for the even-numbered pages or the odd-numbered pages, which image data have thus been stored in the storage section of the image forming apparatus, are held in the storage section until the stored image data for the even-numbered pages or the odd-numbered pages have been utilized for the formation of the image represented by the image information, which image formation is iterated the number of times equal to the number of the plurality of the copies, and
c) the image data for the remaining pages, which remaining pages are other than the even-numbered pages or the odd-numbered pages, are outputted from the print control apparatus into the image forming apparatus and in the order of the pages, the outputting of the image data for the remaining pages from the print control apparatus into the image forming apparatus being iterated the number of times, which is equal to the number of the plurality of the copies, and
the image formation controlling means controls the image forming apparatus such that the image forming apparatus iterates an image forming process the number of times, which is equal to the number of the plurality of the copies, the image forming process comprising the reading of the image data for the even-numbered pages or the odd-numbered pages, which image data are held in the storage section of the image forming apparatus, the acceptance of the image data for the remaining pages, which image data are outputted from the print control apparatus, and the formation of the image represented by the image information, which is composed of the image data for the even-numbered pages or the odd-numbered pages having been read from the storage section of the image forming apparatus and the image data for the remaining pages having been accepted from the print control apparatus.

5. An image forming apparatus for use in an image forming system as defined in claim 3, the apparatus comprising:
i) the storage section, which is capable of storing the image data for at least one page, and
ii) the image formation controlling means for controlling such that the image forming process is iterated the number of times, which is equal to the number of the plurality of the copies, the image forming process comprising the reading of the image data for the predetermined pages, which image data are held in the storage section of the image forming apparatus, the acceptance of the image data for the remaining pages, which image data are outputted from the print control apparatus, and the formation of the image represented by the image information, which is composed of the image data for the predetermined pages having been read from the storage section of the image forming apparatus and the image data for the remaining pages having been accepted from the print control apparatus.

6. An image forming apparatus as defined in claim 5 wherein the image data for the predetermined pages are the image data for even-numbered pages or the image data for odd-numbered pages.
